(19) United States
(12) Patent Application Publication
(10) Pub. No.: US 2004/0198403 A1
(43) Pub. Date: Oct. 7, 2004

(54) Gaming concept for wireless terminals

(76) Inventors: Claus Aagaard Pedersen, Copenhagen Oe (DK); Jens Benner, Copenhagen Oe (DK); Christian Kraft, Hvidovre (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/201,963

(22) Filed: Jul. 25, 2002

(51) Int. Cl. H04Q 7/20

(52) U.S. Cl. 455/517; 455/426.1; 455/414.1

(57) ABSTRACT

A multi party game is played on a plurality of wireless terminals. The game is initiated by opening a game application in a first wireless terminal and identifying at least one further wireless terminal as a game party. The at least one further wireless terminal is invited to participate in said multi party game by sending an invitation message. Upon reception of this invitation message, the game application in the invited wireless terminal opens the game application and stores the information about the inviting terminal for use in the further communication. The replying to said invitation message by establishing an message exchange session, said messages are send based on the information present in the invitation message, and contains user entered draws in the multi party game.

### BACKGROUND OF THE INVENTION

The invention relates to a concept for playing multi-party games by means of at least two wireless terminal via a communication network.

Presently electronic games have been played on special game consoles, Personal Computers and even cellular phones. Some of the unit have been adapted for two-party gaming by means of a cable interconnection or an infrared link.

### SUMMARY OF THE INVENTION

According to a first aspect of the invention there is provided a method of handling multi-party games played on a plurality of wireless terminals. According to this aspect of the invention a game application is opened in a first wireless terminal, and at least one further wireless terminal is identified and invited to participate as a game party by sending an invitation message. Upon reception of this invitation message in said least one further wireless terminal, a game application will be opened in said at least one further wireless terminal. A message exchange session is established by replying to said invitation message, and the messages are send based on the information present in the invitation message, and contains user entered draws in the multi party game. According to the first aspect of the invention these is provided a gaming concept where two or more users can agree in having a game session where the parties once the session has been started just has to concentrate on playing the game moves while the terminals automatically send the session messages for exchanging information between the game engines handling the multi-party gaming.

This concept will be especially valuable for two party games as chess, noughts and crosses, Othello, and backgammon. For chess the concept bring correspondence chess into a wireless era.

Furthermore the game application may include a timer accumulating the time the user uses for making the game draws. Preferably the timer measures the time from opening the game message to sending the entered game move. According to a first embodiment of the invention the game application displays the accumulated time.

According to a second embodiment of the invention the user, when entering a game move into the game application, is offered to enter further content to be included into the game message. This further content may include a text string.

According to a first embodiment of the invention, a game session record is generated upon initiation of a game session, and the game session record includes information about games parties, identification of the game of the game session, and status information based on game moves carried out.

According to a second aspect of the invention, there is provided a wireless terminal having comprising a game application for handling multi-party game played between at least two wireless terminals, said game application, when opening a new game session from a first wireless terminals, has a user interface allowing the user to identify at least one further wireless terminal as further game parties, memory means for storing information about the invited further parties and the selected game application, and a message application for sending message content to at least one further wireless terminal. The game application when a game move and identification of at least one further wireless terminal has been entered, transfers these data automatically to the message application. According to the second aspect of the invention these is provided a gaming concept where two or more users can agree in having a game session where the parties once the session has been started just has to concentrate on playing the game moves while the terminals automatically send the session messages for exchanging information between the game engines handling the multi-party gaming.

### BRIEF DESCRIPTION OF THE DRAWINGS

For a better understanding of the present invention and to understand how the same may be brought into effect reference will now be made, by way of example only, to accompanying drawings, in which:

FIG. 1 schematically illustrates a first embodiment of a hand portable phone according to the invention.

FIG. 2 schematically shows the essential parts of a telephone for communication with e.g. a cellular network.

FIG. 3 shows a message exchange session for a four party card play session according to one embodiment of the invention.

FIG. 4 shows a show a display for a Chess game embodiment of the invention.

FIG. 5 shows a display for an Opposite game embodiment of the invention.

FIG. 6 shows a flow chart for a two party game according to the invention.

FIG. 7 schematically illustrates a second embodiment of a hand portable phone according to the invention.

FIG. 8 and 9 shows displays for a Backgammon game embodiment of the invention.

### DETAILED DESCRIPTION OF THE INVENTION

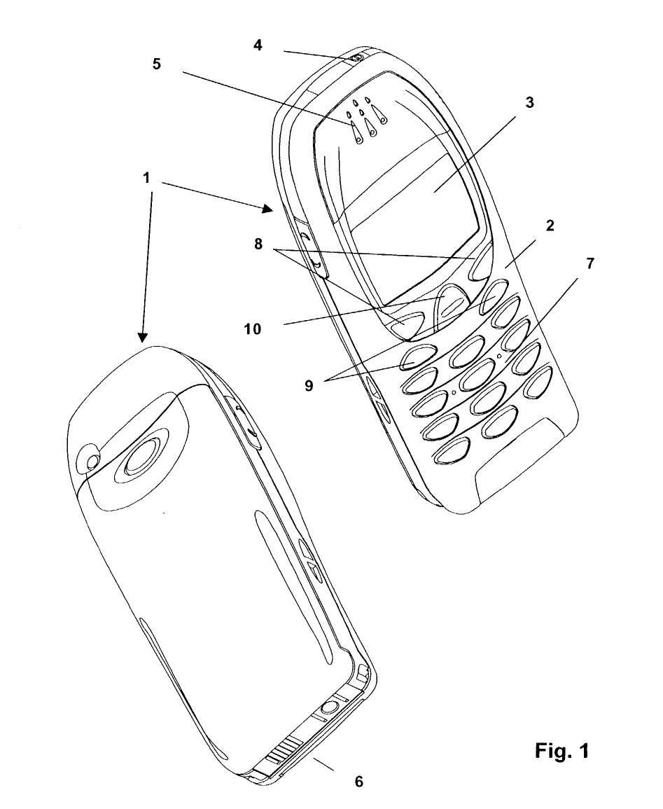

FIG. 1 shows a preferred embodiment of a terminal for handling payment of downloadable content according to the invention, such as a cellular phone 1, which comprises a user interface having a keypad 2, a display 3, an on/off button 4, a speaker 5 (only openings are shown), and a microphone 6 (only openings are shown).

According to a first embodiment of the invention the keypad 2 has a first group 7 of keys as alphanumeric keys, two softkeys 8, and a scroll-key 10 (up/down) for moving a cursor in the display. Furthermore the keypad includes two call-handling keys 9 for initiating and terminating calls. The present functionality of the softkeys 8 is shown in a separate field in the bottom of the display 3 just above the softkeys 8.

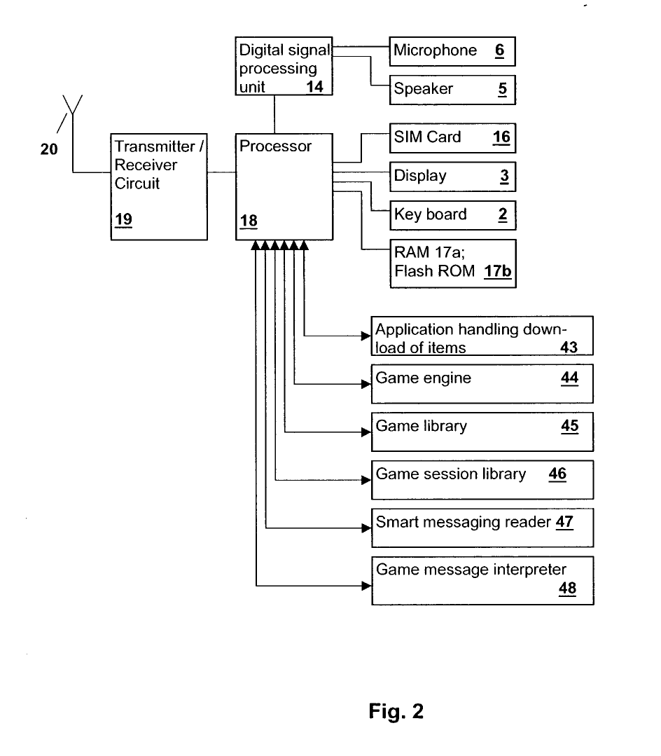

FIG. 2 schematically shows the most important parts of a preferred embodiment of the phone, said parts being essential to the understanding of the invention. A processor 18, which supports the GSM terminal software, also controls the communication with the network via the transmitter/receiver circuit 19 and an antenna 20.

The microphone 6 transforms the users speech into analogue signals; the signals formed thereby are A/D converted in an A/D converter (not shown) before the speech is encoded in an audio part 14. The encoded speech signal is transferred to the processor 18. The processor 18 also forms the interface to a RAM memory 17a and a Flash ROM memory 17b, a SIM card 16, the display 3 and the keypad 2 (as well as data, power supply, etc.). The audio part 14 speech-decodes the signal, which is transferred from the processor 18 to the earpiece 5 via a D/A converter (not shown).

A game message containing information about a game move can be transmitted over the air interface e.g. using a game message format. Such a game message format may be included into the Nokia Smart Messaging Specification. Implementation of such a service depends on the handset capabilities. A handset according to the preferred embodiment invention can set up a game application when receiving an invitation message, update game session when receiving a game message, providing a game message based on game settings entered into the game session when the user enters a game move.

The game message according to a preferred embodiment includes a NBS (Narrow Band Specification) port identification number a predetermined hexadecimal number), as specified in the “Narrowband Sockets Specification”, revision 1.0, Mar. 7,1997, whereby a smart messaging reader 47 is able to recognise a received message as a game message.

Once a message is identified as a game message the content of the message is transferred to a game message interpreter 48 running on the processor 18. The game message interpreter 48 breaks down the game message to its individual part identifying the game session number, the move of the game, and additional content if included.

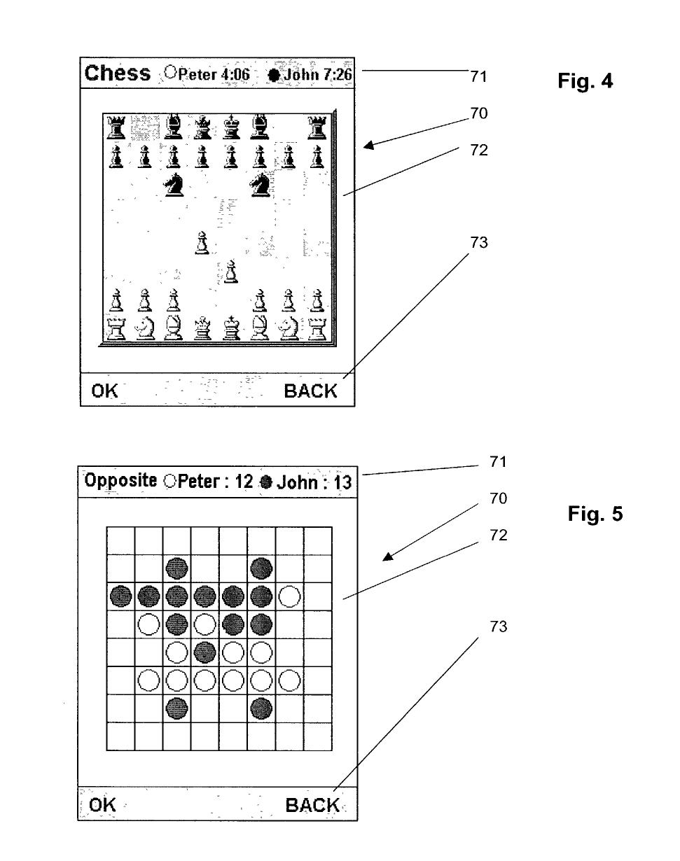

The individual parts identified by the game message interpreter 48 is transferred to a game engine 44, which based on the game session number fetches the associated game session file (see table 1) from a game session library 46. The game engine 44 updates the game session file by adding the recently received game move to the list of moves already being present in the record. The game engine 44 identifies the game application from the game session file, opens the identified game application from a game library, enters the game moves and displays the current diagram for the game in a terminal display 70 as shown in FIG. 4. The terminal display 70 includes a header 71 notifying that chess is currently played and that the two players Peter and John has used 4.06 minutes and 7.26 minutes, respectively. It is white to make the next move and therefor the time for Peter will be running from the time the application was opened until the move has been entered. The start time is fetched from the game session file and the time in the game session file will be replaced by the new time once the move is entered.

TABLE 1
content of game session file
Game session no. < 5 >

Game application: < Chess Nokia version 3.2.0 > <
www.club.nokia.com>
Participants
Player 1 (white): < Peter >; < game session no. 5 >; < +4540790020 >;
< player 1 time >
Player 2 (black): < John >; < game session no. 2 >; < +4522229999 >;
< player 2 time >
Moves < 1. e3 Nc6; 2. d4 Nf6; >

Preferably any additional content included in the game message—such as a text message from the other party is displayed to the user prior to the display of the game diagram.

The other gaming party's movement of a chessman is shown as animation when opening the chess application and displaying the diagram. According to the preferred embodiment of the invention the game application offers the user to move one chessman by marking this chessman—the chessman may be marked by letting the chess field gleam (this is not shown in the figures). The user may select between allowable chessmen by using the alphanumeric keys—e.g. “2, 4, 6, and 8” for moving the gleaming chess field, and select the field by pressing “5”.

Once the user has selected which chessman he wants to move by selecting the origin field, the game application offers the user to move the selected chessman to a destination field by marking this second field by letting the chess field gleam (this is not shown in the figures). The user may select between allowable destination fields by using the alphanumeric keys—e.g. “2, 4, 6, and 8” for moving the gleaming chess field, and select the field by pressing “5”.

A variant within the scope of the gaming concept according to the invention is to generate a pop-up field into which the user is invited to enter the origin and the destination co-ordinates—e.g. “d2-d4” of the move he wants to make.

Once the move has been entered the user may approve the move by pressing the right softkey 8 having the “OK” label displayed in the softkey label field 73. Long-pressing “Back” will cause the terminal to quit the game application, while short pressing (shorter than 0.8 sec) just will delete the entered moves/data. Then a menu is displayed including “Send move”, and “Add text” is displayed. If the user selects add text a message window is opened, and when the text has been entered, the text will be included as additional content and included in the game message send to the other game party based on the data included in the game session file. The game session file is updated with the recently entered move and the file is closed.

FIG. 5 shows a display for a two party Opposite-game played between two terminals according to the invention. The placement of a game piece and the changes this causes is shown as animation when opening the game application and displaying the game diagram. According to the preferred embodiment of the invention the game application offers the user to place a game piece by marking a game field—the game piece may be marked by letting the game field gleam (this is not shown in the figures). The user may select between allowable fields by using the alphanumeric keys—e.g. “2, 4, 6, and 8” for moving the gleaming game field, and select the field by pressing “5”.

Once the game piece has been placed has been entered the user may approve the placement by pressing the right softkey 8 having the “OK” label displayed in the softkey label field 73. Then a menu is displayed including “Send move”, and “Add text” is displayed. If the user selects add text a message window is opened, and when the text has been entered, the text will be included as additional content and included in the game message send to the other game party based on the data included in the game session file. For Opposite the game session file includes information about the position and color of each of the game pieces. The game session file is updated with the results of the recently entered game piece and the file is closed.

Instead of using the alphanumeric keys for moving and selecting game pieces, special game keys may according to other embodiments of the invention be integrated in the terminal.

When dealing with games with a degree of luck included, it is important to protect the game session file against editing in order to avoid cheating.

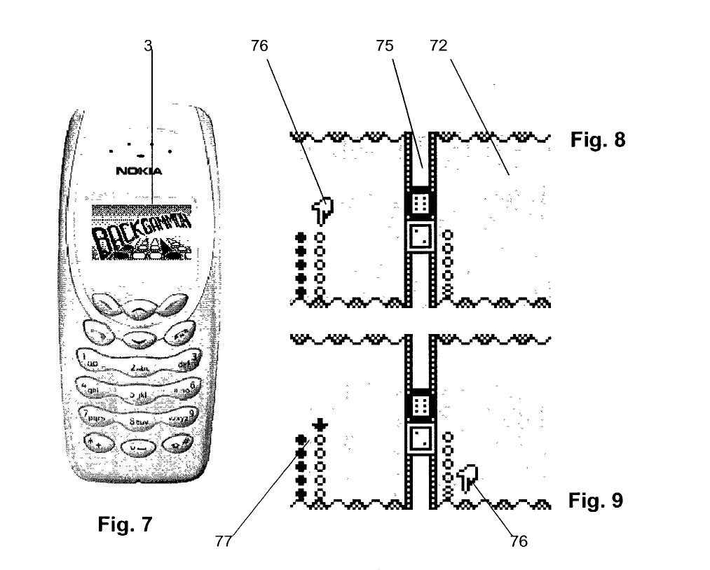

FIG. 7 shows a further embodiment of the invention. A terminal 1 displays a welcome animation in the display 3 when starting up a Backgammon game application. During starting up the application the game session file is updated by adding moves done by the other game party and received in the game message. The moves done by the other game party are shown as animation.

The user has to through two dices, and this is handled by a random generator provided by the game engine. This must not be controlled by the used because he will be able to cheat. Once the dices are thrown, the results are entered into the game session file. The dices are shown on a vertical bar 75 of the diagram display 72.

According to the preferred embodiment of the invention the game application offers the user to move one game piece by marking this game piece—the game piece may be marked by means of a hand shaped cursor 76. The user may select between allowable game piece by using the alphanumeric keys—e.g. “2, 4, 6, and 8” for moving the hand shaped cursor 76, and select the column by pressing “5”. Then an arrow 77 will mark the origin column.

The user may select between allowable destination column by using the alphanumeric keys—e.g. “2, 4, 6, and 8” for moving the hand shaped cursor 76, and select the column by pressing “5”. If the user has to throw the dices once more this is done as explained above.

Once the game pieces has been placed by the user, he has to may approve the placement by pressing the right softkey 8 having the “OK” label displayed in the softkey label field 73. Then a menu is displayed including “Send move”, and “Add text” is displayed. If the user selects “Add text”, a message window is opened, and when the text has been entered, the text will be included as additional content and included in the game message send to the other game party based on the data included in the game session file. For Backgammon the game session file includes information about the position and colour of each of the game pieces. The game session file is updated with the results of the recently entered game piece and the file is closed.

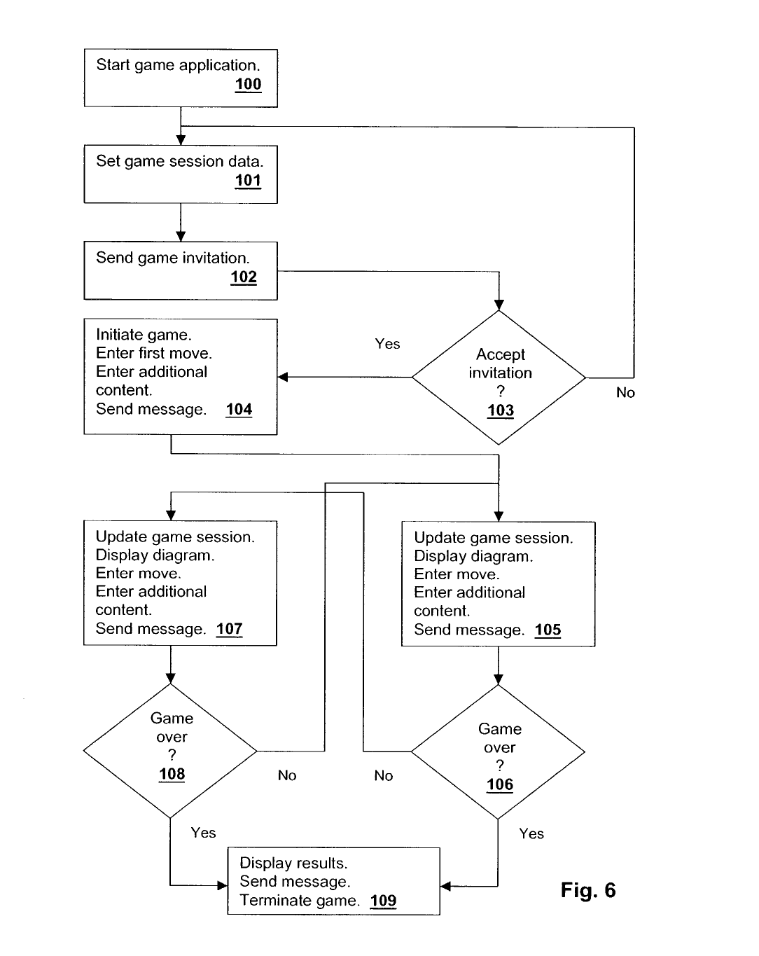

FIG. 6 illustrates the method according the invention for handling a two party game played on two wireless terminals. One user opens a new game session by opening a game application on his cellular telephone (the inviting wireless terminal) in step 100. The user enters the data identifies the other game party and the game he want to play in step 101. Hereby he also establishes a game session file including these data and data about the game application. Then he sends an invitation message including the user entered data and data from the game session file including data about the game application, to the identified other party in step 102. This is done automatically from the game application.

If the invited party accepts the invitation in step 103, the invited terminal establishes a game session file which game session number is communicated back to the inviting terminal in the reply message. The invited terminal may have to update the game application if needed, by using the Internet address provided with the game information received in the invitation message.

If the invited party has accepted the invitation, the inviting terminal decides by lot whom to start the game. If the inviting party has to start e.g. a chess game, the user enters the opening move. He may also enter additional content, e.g. a text message, and when this is done a message is automatically send to the invited party in 104.

Here the game session file is updated and animation showing the opening move is displayed. The invited party may now enter a move as described with reference to FIG. 4 and additional content if desired in step 105. In step 106, the game engine in invited terminal evaluates whether the game is over or not.

If the game is still on going a game message is send to the inviting terminal which updates the game session file and an animation showing the done move is displayed. The inviting party may now enter a move as described with reference to FIG. 4 and additional content if desired in step 107. In step 108, the game engine in inviting terminal evaluates whether the game is over or not.

Step 105-108 is repeated as long as the game is still ongoing including sending of messages. If one player has won, lost or gives up this is detected at step 106 or 108. A celebration message is send to the other party informing it about the win or loss, and the game is terminated in step 109. The user may the delete the game session file or transfer it to a Personal Computer for evaluation.

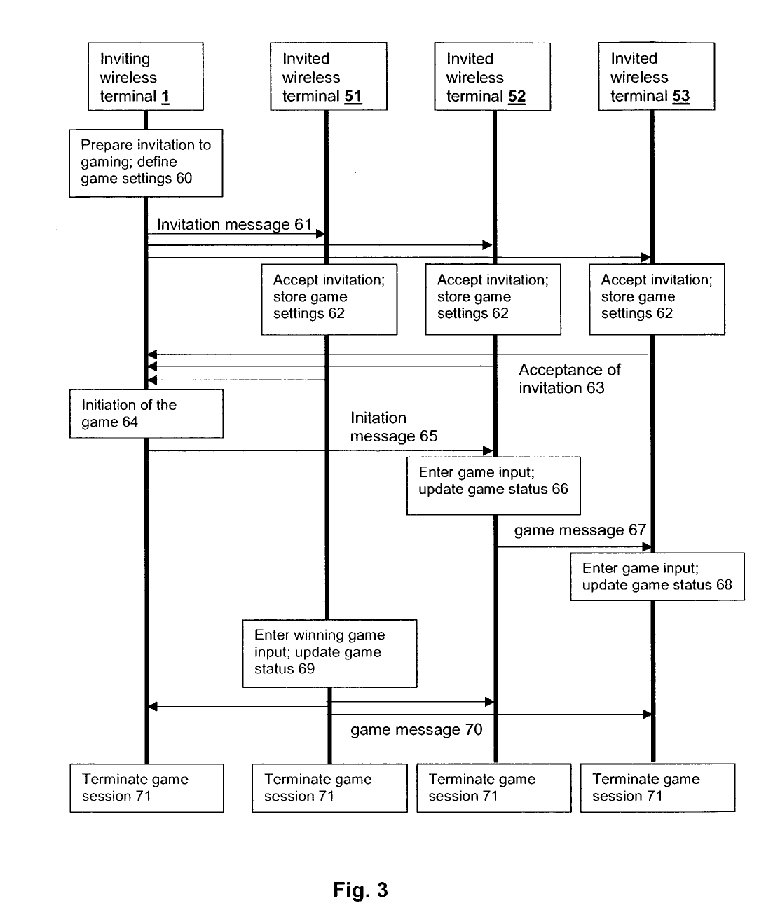

FIG. 3 shows a game message pattern for a four party card playing session. An inviting terminal 1 opens a new game session by opening a game application on his cellular telephone. The user enters the data identifies the other game parties and the game he want to play, e.g. poker. Hereby he also establishes a game session file 60 including these data and data about the game application. Then he sends an invitation message 61 to each of the invited terminals, including the user entered data and data from the game session file including data about the game application, to the identified other parties. This is done automatically from the game application.

If the invited parties accepts and establishes a game session file 62 this is communicated back to the inviting terminal in the reply message 63. The invited terminals may have to update the game application by using the Internet address provided with the game information received in the invitation message 61.

When all parties have accepted, the inviting party starts the card game. He players plays in practice against their own game engines, but the engines are linked by distributing data about each players cards, whereby the four players virtually plays against each other by exchanging game messages 65,67 including the history of the game so the game engines are able to play exactly the same game controlled 66, 68 by the four participants.

This exchange of messages is continued as long as the game is still ongoing. When a winner is found 69, celebration messages 70 are send to the other parties informing it about the win or loss, and the game is terminated.

Instead of including the history into the messages, each terminal could distribute every entered input to all the other game parties. This would raise the number of messages in the game by a factor three.

The concept is based on using traditionally messaging facilities in a cellular network—e.g. the Short Messaging Service available in GSM. Chatting between the parties will be available during the gaming. The speed will be rather slow because the users may send one message in the train to work in the morning and receive the reply when going home in the evening.

A game based on SMS, enabling users to play Backgammon, Chess or Opposite and Chat without time constraints and without location constraints. For operators the selling point is that they are given a whole micro payment-billing infrastructure for free with this solution, e.g. they charge for every SMS sent back and forth.

It is possible to leave the game, and return to game upon new move received. Play through time (projection): In principle infinite, on average estimated 40-100 moves in dependence of the chosen game.

The game concept may cover a preinstalled Backgammon midlet for the cellular handset, enabling two users to play Backgammon against each others using Java SMS API.

According to the invention game engines, based on e.g. midp java applications (midlets), especially turn based games, interacts with each other although they are being executed on different handsets. When based on midp java applications (midlets), the handset has to support MIDP java as defined by Sun Microsystems, and also support the Nokia SMS API as defined by Nokia. The Nokia SMS API enables sending and receiving of SMS's from within midlets.

MIDP java enabled handsets will contain a generic application platform that supports download and execution of small applications (midlets). In other words, users will be able to customise and tailor the functionality of the handset, instead of just being limited to the fixed set of native applications that the phones are been born with. Another advantage of java enabled phones is the possibility to make so called OEM specific API's, e.g. API's which can be used by midlets to make use of underlying phone functionality, not supported by MIDP java alone. The SMS API is such an API. With these technologies in place, a platform for new applications is getting ready, and players of turn based games, such as chess, backgammon, connect-four, TickTackToe, etc. can play against each other, with no limitations like time, mutual proximity or demographic placement.

The idea has been to develop different kind of turn-based games written in MIDP Java, and using the Nokia SMS API. These games will use the SMS sending and receiving capabilities to send and receive the moves of the turn based games, e.g. it is possible to encode moves or board representations of the actual game and send and receive these moves or board representations between two or more GSM phone recipients. The Nokia SMS API is designed such that a midlet can encode an SMS and send it to a GSM number on a specific port (like smart-messaging, also defined by Nokia) while running. SMS receiving is designed such that, if the phone has the same midget installed, and that phone receives an SMS on the specific port, it either asks the user if he/she wants to start up the midget so that the SMS can be processed by the midget, or if the mildest is already running, it processes the midget tacitly. E.g. it can thus be transparent for the user that an SMS is actually received because the only thing that is shown is perhaps a small sound indication and a graphically indication of the move received on the game board drawed on the screen of the handset.

Making use of MIDP Java and the Nokia SMS API, it is now possible to develop downloadable turn based multi-player games, where the users do not need to be close to each other while playing, or where the users do not need to spend expensive airtime running a WAP session while playing a WAP game. E.g. the only two ways it has been possible to play multi-player games on Nokia handsets so far, has been either with the snake 11 game, where moves of the snake is sent over infrared, but where the handsets needs to be in close proximity to each other, or by means of WAP, where the user needs to be running a WAP session continuously to maintain receiving and sending of game moves. Making use of SMS's to send moves could have been done with a native handset application as well, but then it would not have been possible to delete this SMS game and download a new one afterwards.

The game may be implemented together with the possibility of chatting simultaneously with playing the game. Gaming is a social thing, and being able to send small messages together with the game would extend the feeling of being “connected” with the opponent.

The games according to the invention can be preloaded on the phone for sale packages. This would give the manufacturer an advantage of branding the game, and also open up for possibilities where upgrades may be fetched from an Internet address set by the manufacturer, e.g. as a site where more levels of a game, colours, game features could be downloaded, or where other opponents can be found.

What is claimed is:

1. A method of handling multi party games played on a plurality of wireless terminals, comprising:
opening a game application in an inviting wireless terminal,
setting game settings including
selection of the game;
identifying at least one further wireless terminal as a game party,
inviting said at least one further wireless terminal to participate in said multi party game by sending an invitation message, said invitation message includes said game settings,
receiving said invitation message in said least one further wireless terminal,
accept the invitation, whereby the received game settings are transferred to a game application in said at least one further wireless terminal for multi party game,
whereby the game session is carried out by exchanging game inputs in turns by sending messages to the other game parties based on the game settings set by the invitating party.

2. A method according to claim 1, wherein the multi-party game is a two party game, and is selected from a group of games including:
chess,
noughts and crosses,
othello, and
backgammon.

3. A method according to claim 2, wherein the multi-party game is correspondence chess.

4. A method according to claim 3, wherein the game application includes a timer accumulating the time the user uses for making the game draws.

5. A method according to claim 4, wherein the timer measures the time from opening the game message to sending the entered game move.

6. A method according to claim 5, wherein the game application displays the accumulated time.

7. A method according to claim 1, wherein the user, when entering a game move into the game application, is offered to enter further content to be included into the game message.

8. A method according to claim 7, wherein the further content includes a text string.

9. A method according to claim 1, wherein a game session record is generated upon initiation of a game session, and the game session record includes:
information about games parties,
identification of the game of the game session, and
status information based on game moves carried out.

10. A method of handling multi party games played on a plurality of wireless terminals, comprising:
opening a game application in a first wireless terminal,
identifying at least one further wireless terminal as a game party,
inviting said at least one further wireless terminal to participate in said multi party game by sending an invitation message, said invitation message identifies the first wireless terminal,
receiving said invitation message in said least one further wireless terminal,
opening a game application in said at least one further wireless terminal for multi party game,
replying to said invitation message by establishing an message exchange session, said messages are send based on the information present in the invitation message, and contains user entered draws in the multi party game.

11. A method according to claim 10, wherein the multi-party game is a two party game, and is selected from a group of games including:
chess,
noughts and crosses,
othello/opposite/reversi, and
backgammon.

12. A method according to claim 11, wherein the multi-party game is correspondence chess.

13. A method according to claim 12, wherein the game application includes a timer accumulating the time the user uses for making the game draws.

14. A method according to claim 13, wherein the timer measures the time from opening the game message to sending the entered game move.

15. A method according to claim 14, wherein the game application displays the accumulated time.

16. A method according to claim 10, wherein the user, when entering a game move into the game application, is offered to enter further content to be included into the game message.

17. A method according to claim 16, wherein the further content includes a text string.

18. A method according to claim 10, wherein a game session record is generated upon initiation of a game session, and the game session record includes:
information about games parties,
identification of the game of the game session, and
status information based on game moves carried out.

19. A method of handling two party games played between two wireless terminals, comprising:
opening a game application in a first, inviting wireless terminal,
identifying second wireless terminal as a second game party,
inviting said second wireless terminal to participate in said game by sending an invitation message, said invitation message identifies the inviting wireless terminal,
receiving said invitation message in said invited wireless terminal,
opening a game application in said invited wireless terminal for the game,
replying to said invitation message by establishing an message exchange session, said messages are send based on the information present in the invitation message, and contains user entered draws in the game.

20. A method according to claim 19, wherein the two party game is selected from a group of games including:
chess,
noughts and crosses,
othello, and
backgammon.

21. A method according to claim 20, wherein the two party game is correspondence chess.

22. A method according to claim 21, wherein the game application includes a timer accumulating the time the user uses for making the game draws.

23. A method according to claim 22, wherein the timer measures the time from opening the game message to sending the entered game move.

24. A method according to claim 23, wherein the game application displays the accumulated time.

25. A method according to claim 20, wherein the user, when entering a game move into the game application, is offered to enter further content to be included into the game message.

26. A method according to claim 25, wherein the further content includes a text string.

27. A method according to claim 19, wherein a game session record is generated upon initiation of a game session, and the game session record includes:
information about games parties,
identification of the game of the game session, and
status information based on game moves carried out.

28. A wireless terminal having comprising
a game application for handling multi-party game played between at least two wireless terminals,
said game application, when opening a new game session from a first wireless terminals, has a user interface allowing the user to identify at least one further wireless terminal as further game parties,
memory means for storing information about the invited further parties and the selected game application,
a message application for sending message content to at least one further wireless terminal,
said game application when a game move and identification of at least one further wireless terminal has been entered, transfers these data automatically to the message application.

29. A wireless terminal 28, and comprising
a game library containing at least one executable software code for the individual games, and
game session library containing information about games parties, identification of the game of the game session, and status information based on game moves carried out.

30. A wireless terminal 28, wherein the multi-party game is a two party game, and is selected from a group of games including:
chess,
noughts and crosses,
othello, and
backgammon.

31. A wireless terminal according to claim 30, wherein the two party game is correspondence chess.

32. A wireless terminal according to claim 31, wherein the game application includes a timer accumulating the time the user uses for making the game draws.

33. A wireless terminal according to claim 32, wherein the timer measures the time from opening the game message to sending the entered game move.

34. A wireless terminal according to claim 32, wherein the terminal includes a display in which the game application displays the accumulated time.

35. A wireless terminal according to claim 28, wherein the game application, when the user has entered a game move into the game application, open a content input window allowing the user to enter further content to be included in the game message.

36. A wireless terminal according to claim 35, wherein the content input window allows the user to enter a text string.

37. A wireless terminal according to claim 28, wherein a game session record is generated upon initiation of a game session, and the game session record includes:
information about games parties,
identification of the game of the game session, and
status information based on game moves carried out.

38. A wireless terminal according to claim 28, wherein a game application for instructs the message application to automatically send a game message once the user has confirmed the entered game move.
